(19) United States
(12) Patent Application Publication
(10) Pub. No.: US 2023/0015523 A1
(43) Pub. Date: Jan. 19, 2023

(54) PERSONAL DATA WALLET

(71) Applicant: PAYPAL, INC., San Jose, CA (US)

(72) Inventor: Sangeetha Mani, Chennai (IN)

(21) Appl. No.: 17/376,633

(22) Filed: Jul. 15, 2021

(51) Int. Cl. G06Q 20/40; G06Q 40/02; G06Q 20/36; G06Q 20/32; G06Q 20/02; G06Q 20/38; G06F 21/62; H04L 29/08

(52) U.S. Cl. CPC G06Q 20/4014; G06Q 40/02; G06Q 20/363; G06Q 20/3674; G06Q 20/326; G06Q 20/02; G06Q 20/383; G06F 21/6245; H04L 67/306; H04L 67/18; H04L 67/20; G06Q 20/3224; G06F 3/0482

(57) ABSTRACT

Methods and systems are presented for providing a secured electronic transaction processing framework that enables online service providers to process electronic transactions for users while allowing the users to retain control over their user data. The secured electronic transaction processing framework includes a data access system configured to dynamically access user data, that is stored on user devices and controlled by users, on an as-needed basis. When a service provider server receives a request for processing a transaction through a user account, the service provider serer may use the data access system to dynamically obtain user data required for processing the transaction from a wallet application of a user device. The wallet application may include data access policies that specify data access settings for different service providers. After processing the transaction using the user data, the service provider server may remove the user data.

### BACKGROUND

The present specification generally relates to electronic data security, and more specifically, to providing a secured electronic transaction processing framework according to various embodiments of the disclosure.

### RELATED ART

With the advent of online services, user data of users has been transmitted to, and stored by, different computer servers and databases at an increasing rate. Every time a user registers with an online service provider or requests the online service provider to perform an electronic transaction, the user may provide user data to the online service provider. The user data may include personal data such as a name, a gender, an age, an identification number (e.g., a social security number, a driver's license number, a passport number, etc.), a birthday, a physical address, an email address, a phone number, etc. The user data may also include financial data such as a bank account number, a payment card number, etc. For an online service provider in the healthcare services, the user data may also include health data, such as a pre-existing health condition, an allergy condition, a blood type, DNA information, etc.

The online service provider may store the user data associated with each of its users in a persistent data storage, such that the online service provider may access the user data subsequently for performing services (e.g., processing electronic transactions, etc.) for the users. In some scenarios, the online service provider may also provide (or otherwise share) the user data to one or more third-party service providers (e.g., a credit bureau, medical laboratory, etc.). The third-party service provider may in turn store the user data in its persistent data storage. As such, under the current scheme, the user has to provide user data to online service providers to access services from the online service providers, and once the user data is provided to the online service providers, the user has no control over where the user data is stored, how it is used, and with whom it is shared. Furthermore, different jurisdictions and/or government agencies have imposed different regulations on how certain types of data (e.g., user identifiable data, health data, financial data, etc.) can be stored and/or processed, which may require the online service provider to create additional computer infrastructure for storing and processing the user data. Thus, there is a need for providing an improved data sharing framework that enables online service providers to provide services to users, while allowing the users to retain control over their user data.

### BRIEF DESCRIPTION OF THE FIGURES

FIG. 1 is a block diagram illustrating a networked system that includes an electronic transaction system according to an embodiment of the present disclosure;

FIG. 2 is a block diagram illustrating a data access module according to an embodiment of the present disclosure;

FIG. 3 illustrates a user interface provided by a wallet application according to an embodiment of the present disclosure;

FIG. 4 illustrates another user interface provided by a wallet application for configuring data access policies for a service provider according to an embodiment of the present disclosure;

FIG. 5 is a flowchart showing a process of registering a new user account according to an embodiment of the present disclosure;

FIG. 6 is a flowchart showing a process of processing a transaction through a user account of a service provider according to an embodiment of the present disclosure;

FIG. 7 is a flowchart showing a process of configuring data access policies for a wallet application according to an embodiment of the present disclosure; and

FIG. 8 is a block diagram of a system for implementing a device according to an embodiment of the present disclosure.

Embodiments of the present disclosure and their advantages are best understood by referring to the detailed description that follows. It should be appreciated that like reference numerals are used to identify like elements illustrated in one or more of the figures, wherein showings therein are for purposes of illustrating embodiments of the present disclosure and not for purposes of limiting the same.

### DETAILED DESCRIPTION

The present disclosure includes methods and systems for providing a secured electronic transaction processing framework that enables online service providers to process electronic transactions for users while allowing the users to retain control over their user data. In some embodiments, the secured electronic transaction processing framework includes a data access system configured to dynamically access user data, that is stored on user devices and controlled by users, on an as-needed basis. The data access system may be associated with an online service provider. Furthermore, the data access system of some embodiments does not store any user data of its users persistently in a data storage associated with an online service provider. When an online service provider receives a transaction request for processing a transaction through a user account (e.g., an onboarding request for creating a new user account, an electronic payment request, a data access request, etc.), the data access system may first determine the types of data needed for processing the transaction request. For example, if the request is an onboarding request, the data access system may determine that only a name (or an identifier of a user, such as a driver's license number) is required to process the transaction request. However, if the request is an electronic payment request, the data access system may determine that a name, payment card information of a payment card, and a shipping address may be required to process the transaction request.

The data access system may then access a personal wallet application of a user device of the user and may attempt to access and retrieve the user data required for processing the transaction through the personal wallet application. The data access system may use the retrieved user data to process the transaction request. After processing the transaction request, the data access system may permanently remove the user data from any data storage of the online service provider. By accessing the required user data only for the duration of processing a transaction request and deleting the user data after processing the transaction request, the data access system and the online service provider may reduce the burden of using particular techniques to store and process sensitive data, as required by various government agencies. Furthermore, by removing data after transaction processing, storage requirements for the service provider system may be reduced.

In some embodiments, the secured electronic transaction processing framework may also include personal data wallet applications that can be executed on user devices of the users. Each instance of the personal data wallet application (e.g., each personal data wallet application executed on a user device) may be associated with a unique wallet identifier. The unique wallet identifier may be generated when the personal data wallet application is downloaded and/or executed on the user device for the first time.

After installing the personal wallet application on a user device, the personal wallet application may provide a user interface for receiving user data from a user. For example, through the user interface, the personal wallet application may prompt the user for user data corresponding to specific user data types, such as a name, a gender, a birthday, an address, a payment card number, etc. Upon receiving the user data corresponding to the requested data type, the personal wallet application may securely store the user data on the user device (e.g., in a portion of a persistent data storage of the user device that is allocated for the personal wallet application). In some embodiments, the personal wallet application may encrypt the user data before storing the encrypted data on the user device.

In some embodiments, the personal wallet application may provide a data access configuration user interface that enables the user to configure data access settings for each data type. Through the data access configuration user interface, the personal wallet application may enable the user to specify, for each data type, an access level (e.g., never allowed, allowed once upon approval, always allowed, etc.) corresponding to each online service provider. As such, the user may specify different access levels for different data types, and may also specify, for each particular data type, different access levels corresponding to different online service providers. For example, the user may specify, for a first data type (e.g., birthday), a first data access level (e.g., always allowed) corresponding to a first online service provider (e.g., a mobile application associated with a coffee shop that offers free coffee on the birthday of the user), but may specify a second data access level (never allowed) corresponding to a second online service provider (e.g., a social network application). Through the personal wallet application and the data access settings, the user may manage the user data and control who may or may not access certain user data.

In some embodiments, the data access system may obtain the data access settings associated with different users from the corresponding personal data wallet applications. The data access system may store the data access settings on one or more servers, such as a centralized server associated with the online service provider, or a distributed network of servers (e.g., edge servers) associated with the online service provider. The data access system may analyze the data access settings and may correlate different data access settings to different attributes of the users (e.g., age, gender, geographical locations, etc.). The data access system may then create different data access models for different types of users. In some embodiments, the data access system may automatically configure the data access settings for a data wallet application based on user attributes associated with the data wallet application (e.g., a location of the user, a gender of the user, a demographic of the user, an age of the user, etc.) and the data access models. Thus, the user may not need to manually configure the data access settings for all of the online service providers that the user may interact with, and may rely on the automatic setting or recommendation, which the user may accept, deny, or revise. The user may subsequently edit and personalize the data access settings as the user uses the personal wallet application.

In some scenarios, in order to process certain transaction requests, the online service provider may be required to use a third-party service provider (e.g., a credit bureau, a medical laboratory, etc.). Instead of sharing the user data that has been retrieved from the personal data wallet application of the user with the third-party service provider, the data access system may provide, to the third-party service provider, the wallet identifier associated with the personal data wallet application of the user. A server or a system of the third-party service provider may then directly communicate with the personal data wallet application of the user based on the wallet identifier and may attempt to retrieve user data of the user for processing the transaction request. Since the server or the system of the third-party service provider directly requests user data from the user via the personal data wallet application, the user can manage and control which data is being shared to the third-party service provider independent from the online service provider.

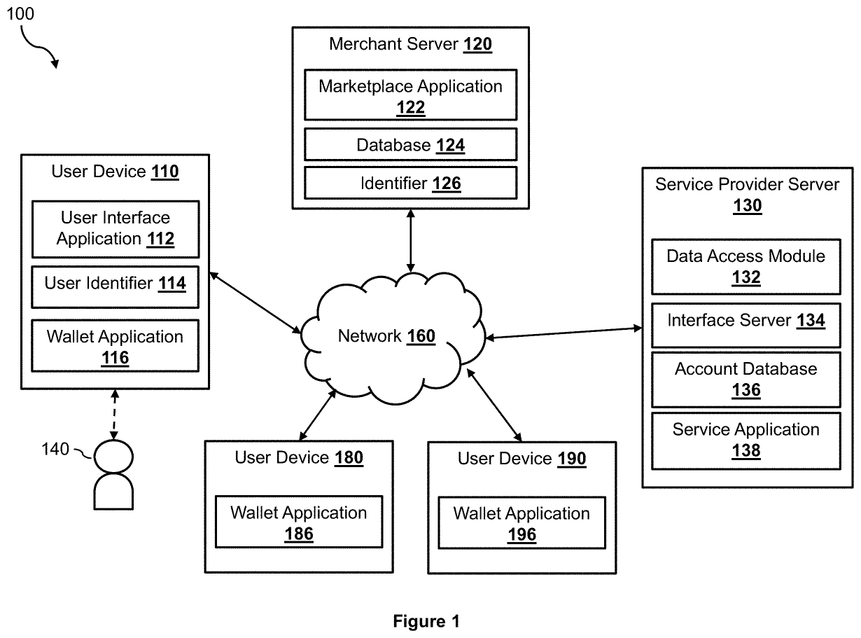

FIG. 1 illustrates a networked system 100, within which the data access system may be implemented according to one embodiment of the disclosure. Note that the present techniques may be applied in many different computing and technological environments, however, and are not limited to those shown in the figures. The networked system 100 includes a service provider server 130, a merchant server 120, and user devices 110, 180 and 190 that may be communicatively coupled with each other via a network 160. The network 160, in one embodiment, may be implemented as a single network or a combination of multiple networks. For example, in various embodiments, the network 160 may include the Internet and/or one or more intranets, landline networks, wireless networks, and/or other appropriate types of communication networks. In another example, the network 160 may comprise a wireless telecommunications network (e.g., cellular phone network) adapted to communicate with other communication networks, such as the Internet.

The user device 110, in one embodiment, may be utilized by a user 140 to interact with the merchant server 120 and/or the service provider server 130 over the network 160. For example, the user 140 may use the user device 110 to conduct an online transaction with the merchant server 120 via websites hosted by, or mobile applications associated with, the merchant server 120. The user 140 may also log in to a user account to access account services or conduct electronic transactions (e.g., account transfers or payments) with the service provider server 130. The user device 110, in various embodiments, may be implemented using any appropriate combination of hardware and/or software configured for wired and/or wireless communication over the network 160. In various implementations, the user device 110 may include at least one of a wireless cellular phone, wearable computing device, PC, laptop, etc.

The user device 110, in one embodiment, includes a user interface (UI) application 112 (e.g., a web browser, a mobile payment application, etc.), which may be utilized by the user 140 to interact with the merchant server 120 and/or the service provider server 130 over the network 160. In one implementation, the user interface application 112 includes a software program (e.g., a mobile application) that provides a graphical user interface (GUI) for the user 140 to interface and communicate with the service provider server 130, and/or the merchant server 120 via the network 160. In another implementation, the user interface application 112 includes a browser module that provides a network interface to browse information available over the network 160. For example, the user interface application 112 may be implemented, in part, as a web browser to view information available over the network 160.

The user device 110 may include a wallet application 116 that implements the personal data wallet application disclosed herein. The wallet application 116 may be configured to store user data associated with the user 140 in a persistent data storage of the user device 110 and manage data accesses of the user data. For example, the wallet application 116 may provide a user interface on the user device 110 for interacting with the user 140. Through the user interface, the wallet application 116 may prompt the user for user data corresponding to various data types. The user 140 may enter user data corresponding to the various data types. The user data received from the user 140 may include personal information such as a name, a gender, a birthday, an age, a driver's license number, a social security number, demographic information, an address, a phone number, etc. The user data may also include financial information such as bank account information (e.g., a bank institution, a bank account number, etc.), payment card information (e.g., a credit card number, an expiration date, a security code, etc.), etc. The user data may also include health information such as a blood type, one or more pre-existing health conditions (e.g., diabetes, high blood pressure, etc.), allergies, vaccine information, etc.

Upon receiving the user data, the wallet application 116 may store the user data on the user device 110. For example, the user data may be stored in a portion of a persistent data storage (e.g., a hard drive, a flash drive, etc.) of the user device 110 that is specifically allocated to the wallet application 116, such that other applications in the user device 110 cannot freely access the user data. The user data may be stored in association with the corresponding data types. In one example, the user data may be stored in a database structure having records, where each record corresponds to a particular data type. Thus, the wallet application 116 may store a name of the user 140 in a record associated with a name data type. The wallet application 116 may also store a credit card number in a record associated with a payment card data type.

In some embodiments, the wallet application 116 may also enable the user 140, via the user interface, to configure data access settings for the different data types and corresponding to different online service providers. For example, the wallet application 116 may receive a first set of data access settings corresponding to the merchant server 120 and may store the first set of data access settings in the database. The first set of data access settings specifies access levels associated with different user data types (e.g., the name, the credit card number, the social security number, etc.) for the merchant server 120. When the merchant server 120 transmits a data request for various user data, the wallet application 116 may determine whether to provide the merchant server 120 access to the user data according to the first set of data access settings. Similarly, the wallet application 116 may receive a second set of data access settings corresponding to the service provider server 130 and may store the second set of data access settings in the database. The second set of data access settings specifies access levels associated with different user data types (e.g., the name, the credit card number, the social security number) for the service provider server 130. When the service provider server 130 transmits a data request for various user data, the wallet application 116 may determine whether to provide the service provider server 130 access to the user data according to the first set of data access settings.

The user device 110, in one embodiment, may include at least one identifier 114, which may be implemented, for example, as operating system registry entries, cookies associated with the user interface application 112 and/or the wallet application 116, identifiers associated with hardware of the user device 110 (e.g., a media control access (MAC) address), or various other appropriate identifiers. In various implementations, the identifier 114 may be passed with a user login request to the service provider server 130 via the network 160, and the identifier 114 may be used by the service provider server 130 to associate the user 140 with a particular user account (e.g., and a particular profile) maintained by the service provider server 130.

In various implementations, the user 140 is able to input data and information into an input component (e.g., a keyboard) of the user device 110. For example, the user 140 may use the input component to interact with the UI application 112 (e.g., to retrieve content from third-party servers such as the merchant server 120, to provide inputs related to a goal to the service provider server 130, etc.).

Each of the user devices 180 and 190 may include similar hardware and software components as the user device 110 to enable their respective users to interact with the merchant server 120 and the service provider server 130 through the user devices 180 and 190. For example, the users of the user devices 110, 180, and 190 may use the respective devices to conduct electronic transactions through different user accounts of the service provider server 130. Furthermore, each of the user devices 180 and 190 also includes a wallet application (e.g., wallet applications 186 and 196, respectively), configured to perform the user data storage and management functionalities for their respective users, in a similar manner as the wallet application 116.

The merchant server 120, in various embodiments, may be maintained by a business entity (or in some cases, by a partner of a business entity that processes transactions on behalf of business entity). Examples of business entities include merchants, resource information providers, utility providers, real estate management providers, social networking platforms, etc., which offer various items for viewing, accessing, and/or purchasing, and process payments for the purchases. As shown, the merchant server 120 may include a merchant database 124 for identifying available items, which may be made available to the user devices 110, 180, and 190 for viewing and purchase by the user.

The merchant server 120, in one embodiment, may include a marketplace application or server 122, which may be configured to provide information (e.g., displayable content) over the network 160 to the user interface application 112 of the user device 110. In one embodiment, the marketplace application 122 may include a web server that hosts a merchant website for the merchant. For example, the user 140 of the user device 110 may interact with the marketplace application 122 through the user interface application 112 over the network 160 to search and view various items available for access and/or purchase in the merchant database 124. The merchant server 120, in one embodiment, may include at least one merchant identifier 126, which may be included as part of the one or more items made available for purchase so that, e.g., particular items are associated with the particular merchants. In one implementation, the merchant identifier 126 may include one or more attributes and/or parameters related to the merchant, such as business and banking information. The merchant identifier 126 may include attributes related to the merchant server 120, such as identification information (e.g., a serial number, a location address, GPS coordinates, a network identification number, etc.).

While only one merchant server 120 is shown in FIG. 1, it has been contemplated that multiple merchant servers, each associated with a different merchant, may be connected to the user device 110 and the service provider server 130 via the network 160.

The service provider server 130, in one embodiment, may be maintained by a transaction processing entity or an online service provider, which may provide processing for electronic transactions between the users of the user devices 110, 180, and 190, and one or more merchants or other types of payees. As such, the service provider server 130 may include a service application 138, which may be adapted to interact with the user devices 110, 180, and 190, and/or the merchant server 120 over the network 160 to facilitate the searching, selection, purchase, payment of items, and/or other services offered by the service provider server 130. In one example, the service provider server 130 may be provided by PayPal®, Inc., of San Jose, Calif., USA, and/or one or more service entities or a respective intermediary that may provide multiple point of sale devices at various locations to facilitate transaction routings between merchants and, for example, service entities.

In some embodiments, the service application 138 may include a payment processing application (not shown) for processing purchases and/or payments for electronic transactions between a user and a merchant or between any two entities (e.g., between two users, etc.). In one implementation, the payment processing application assists with resolving electronic transactions through validation, delivery, and settlement. As such, the payment processing application settles indebtedness between a user and a merchant, wherein accounts may be directly and/or automatically debited and/or credited of monetary funds.

The service provider server 130 may also include an interface server 134 that is configured to serve content (e.g., web content) to users and interact with users. For example, the interface server 134 may include a web server configured to serve web content in response to HTTP requests. In another example, the interface server 134 may include an application server configured to interact with a corresponding application (e.g., a service provider mobile application) installed on the user device 110 via one or more protocols (e.g., RESTAPI, SOAP, etc.). As such, the interface server 134 may include pre-generated electronic content ready to be served to users. For example, the interface server 134 may store a log-in page and is configured to serve the log-in page to users for logging into user accounts of the users to access various services provided by the service provider server 130. The interface server 134 may also include other electronic pages associated with the different services (e.g., electronic transaction services, etc.) offered by the service provider server 130. As a result, a user (e.g., the user 140, users of the user devices 180 and 190, or a merchant associated with the merchant server 120, etc.) may access a user account associated with the user and access various services offered by the service provider server 130, by generating HTTP requests directed at the service provider server 130. In some embodiments, the fragment module integration framework may be implemented within or in association with the interface server 134.

The service provider server 130, in one embodiment, may be configured to maintain one or more user accounts and merchant accounts in an account database 136, each of which may be associated with a profile and may include account information associated with one or more individual users (e.g., the user 140 associated with user device 110, users associated with the user devices 180 and 190) and merchants. In one implementation, a user may have credentials to authenticate or verify identity with the service provider server 130. Thus, the service provider server may store the credentials of the users in corresponding records of the account database 136 associated with the user accounts.

In various embodiments, the service provider server 130 includes a data access module 132 that implements the data access system as discussed herein. As discussed herein, the service provider server 130 may not store certain user data associated with its users in the account database 136. For example, the service provider server 130 may not store any sensitive data that may identify a user (e.g., a name, an identification number, etc.), financial data (e.g., payment card information, bank account information, etc.), and health data. When a need to access certain user data arises (e.g., for processing a transaction such as an onboarding transaction, a payment transaction, etc.), the online service may be configured to dynamically access the user data from a wallet application corresponding to the user account. Thus, instead of storing the user data in the account database 136, the service provider server 130 and/or the data access module 132 may be configured to store, for each user account, a wallet identifier that uniquely identifies a wallet application instance executed on a user device.

When the user interface server 134 and/or the service application 138 receives, from a user device (e.g., the user device 110, the user device 180, or the user device 190, etc.) a transaction request for processing a transaction through a user account, the data access module 132 may determine one or more data types required for processing the transaction. As discussed herein, the user data associated with the user account and corresponding to the one or more data types may not be stored in the account database 136. When the data access module 132 determines that the user data is not available in the account database 136, the data access module 132 may access a wallet identifier associated with the user account in the account database 136. The data access module 132 may then communicate with a wallet application (e.g., the wallet application 116 of the user device 110, the wallet application 186 of the user device 180, or the wallet application 196 of the user device 190, etc.) based on a wallet identifier associated with the user account.

The data access module 132 may access the user data corresponding to the data types required to process the transaction via the wallet application. Upon retrieving the user data from the wallet application, the data access module 132 may temporarily store the user data in a memory, such as a non-persistent memory (e.g., random-access memory (RAM)). The service application 138 may access the user data stored in the memory for processing the transaction. After processing the transaction, the data access module 132 may remove (delete) the user data from the memory.

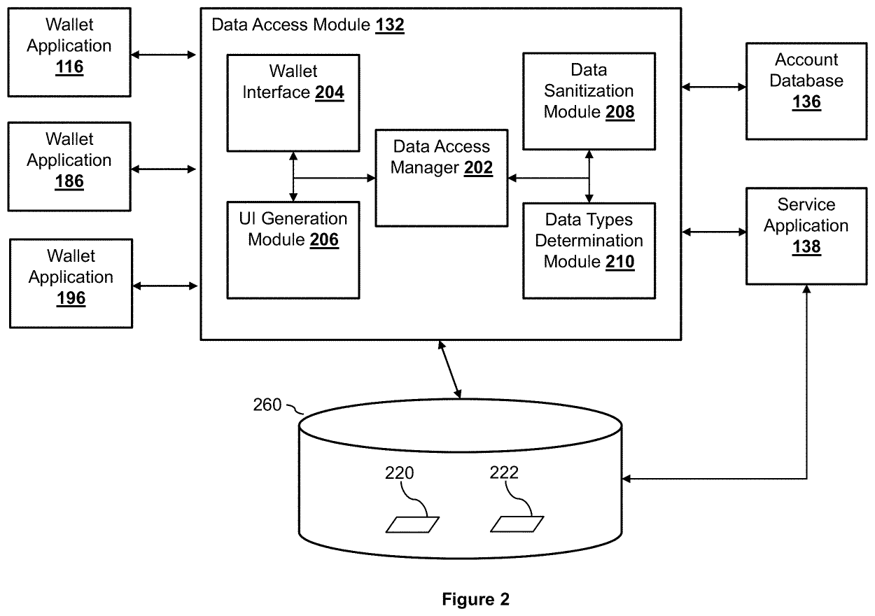

FIG. 2 illustrates a block diagram of the data access module 132 according to an embodiment of the disclosure. The data access module 132 includes a data access manager 202, a wallet interface module 204, a user interface (UI) generation module 206, a data sanitization module 208, and a data types determination module 210. In some embodiments, the data access module 132 may be communicatively coupled to the account database 136 and the service application 138. As discussed herein, the service application 138 may be configured to process transactions for users of the service provider server 130. Each user may be associated with a user account with the service provider server 130. The account database 136 may store data associated with the user account. However, in order to avoid the need for using additional and specialized computation resources to securely store and process certain types of data (also known as “sensitive data”), such as personal identifiable data, health data, financial data, etc., as required by various agencies, the service provider server 130 may not store such types of data in the account database 136. Instead, the service provider server 130 may store, for each user account, a wallet identifier that uniquely identifies a wallet application associated with the user account.

When the service application 138 receives a request to process a transaction through a user account, the service application 138 may request the data access module 132 to obtain user data associated with the user account and required for processing the transaction. The data access manager 202 may use the data types determination module 210 to determine which data types are required for the processing of the transaction. In some embodiments, the data types determination module 210 may determine different types of data that are required for process different types of transactions. For example, the data types determination module 210 may determine a first set of data types (e.g., a name or an identifier of a user, such as a social security number, a residence address, etc.) for an onboarding request. The data types determination module 210 may determine a second set of data types (e.g., a name, payment card information of a payment card, and a shipping address) for a purchase transaction request.

Once the data types determination module 210 determines a set of data types that are required for the service application 138 to process the transaction, the data access manager 202 may access the account database 136. The data access manager 202 may first determine if user data associated with the user account and corresponding to the set of data types are available in the account database 136. For example, if the request is a purchase transaction request, the data access manager 202 may determine whether a name, payment card information, and a shipping address associated with the user account is stored in the account database 136. If any of the user data (e.g., non-sensitive data) is stored in the account database 136, the data access manager 202 may provide the user data retrieved from the account database 136 to the service application 138.

On the other hand, if any of the user data (e.g., sensitive data) required for the service application 138 to process the transaction is not available in the account database 136, the data access manager 202 may retrieve a wallet identifier associated with the user account from the account database 136. The data access manager 202 may use the wallet interface 204 to establish a connection with a wallet application based on the wallet identifier. For example, if the transaction request is for processing a transaction through the user account associated with the user 140, the wallet interface 204 may establish a connection with the wallet application 116 of the user device 110. After establishing a connection with the wallet application 116, the data access manager 202 may request access for the user data corresponding to the data types determined for the transaction request. For example, when the request is for processing a purchase transaction, the data access manager 202 may request, through the wallet interface 204, access to a name of the user 140, payment card information associated with a payment card of the user 140 (e.g., a card number of a payment card, an expiration date of the payment card, a security code, a billing address, etc.), and a shipping address of the user 140.

The wallet application 116 may provide the data access module 132 access to the requested user data based on data access settings corresponding the data types (e.g., a name data type, a payment card information data type, a shipping address data type, etc.) for the service provider server 130. As discussed herein, the wallet application 116 may determine different access settings for different data types and different data requestors (e.g., different service providers). In some embodiments, the wallet application 116 provides a user interface on the user device 110 for interacting with the user 140. Through the user interface, the wallet application 116 may prompt the user for user data corresponding to various data types. The user 140 may enter user data corresponding to the various data types. The user data received from the user 140 may include personal information such as a name, a gender, a birthday, an age, a driver's license number, a social security number, demographic information, an address, a phone number, etc. The user data may also include financial information such as bank account information (e.g., a bank institution, a bank account number, etc.), payment card information (e.g., a credit card number, an expiration date, a security code, etc.), etc. The user data may also include health information such as a blood type, one or more pre-existing health conditions (e.g., diabetes, high blood pressure, etc.), allergies, vaccine information, etc.

The wallet application 116 may store the user data associated with the user 140 in a portion of a persistent data storage (e.g., a hard drive, a flash drive, etc.) of the user device 110. In some embodiments, to enhance security of the user data, the wallet application 116 may encrypt the user data before storing the encrypted data in the persistent data storage. In some embodiments, the wallet application 116 may also enable the user 140, via the user interface, to configure data access settings for the different data types and for different data requesters (e.g., different online service providers, etc.).

In some embodiments, the wallet application 116 may prompt the user to specify data access settings for the various user data the user provided to the wallet application 116 through a menu (e.g., a setting option) of the wallet application 116. The data access settings may be applicable generally to all data requesters (e.g., any service providers that request for user data), or specifically for different data requesters. In some embodiments, the wallet application 116 may automatically prompt the user 140 to specify data access settings for the various user data provided by the user 140. For example, after receiving the user data from the user 140, the wallet application 116 may receive a data request from a data requester (e.g., the merchant server 120, the service provider server 130, or other service providers). The data request may be request based on a transaction request that the user 140 submitted to a service provider. In one example, the user 140 may use the user interface application 112 to communicate with a service provider (e.g., the interface server 134 of the service provider server 130). The user 140 may, via the user interface application 112, log in to a user account with the service provider server 130, such as by providing an identifier or credentials (e.g., a password) associated with the user account. The user 140 may also transmit, to the service provider server 130, a request for processing a transaction (e.g., a purchase transaction for purchasing goods or services associated with the merchant server 120) through the user account associated with the user 140.

As discussed herein, upon receiving the transaction request from the user device 110, the data access module 132 may determine whether user data associated with the user account and required for processing the transaction is available in the account database 136. If the user data is not available, the data access module 132 may determine a wallet identifier associated with the user account and may establish a connection with a wallet application (e.g., the wallet application 116 of the user device 110). The data access module 132 may then transmit a data access request for the user data that is required for processing the transaction (e.g., a name, payment card information of a payment card, and a shipping address).

Upon receiving the data request from the data access module 132 of the service provider server 130, the wallet application 116 may determine whether data access settings corresponding to requested data types have been determined for the service provider server 130. As discussed herein, the user 140 may specify different data access settings (e.g., different data access profiles) for different data requesters. If it is determined that the data access settings corresponding to the requested data types for the service provider server 130 have not been determined, the wallet application 116 may prompt the user 140 for providing the data access settings before determining whether to provide the data access module 132 access to the requested user data. It is noted that the user 140 may use the same device (e.g., the user device 110) or a different user device (e.g., a work computer, a public computer, etc.) to transmit the transaction request to the service provider server 130. When the user uses a different computer device to transmit the transaction request to the service provider server, the data access manager 202 may still be able to determine the wallet application of the user device 110 based on the wallet identifier and may process the transaction request for the user based on the user data retrieved from the wallet application. After processing the transaction request using user data retrieved from the wallet application 116 of the user device 110, the data access manager 202 and/or the service application 138 may provide a transaction request process confirmation to the device that initiated the transaction request.

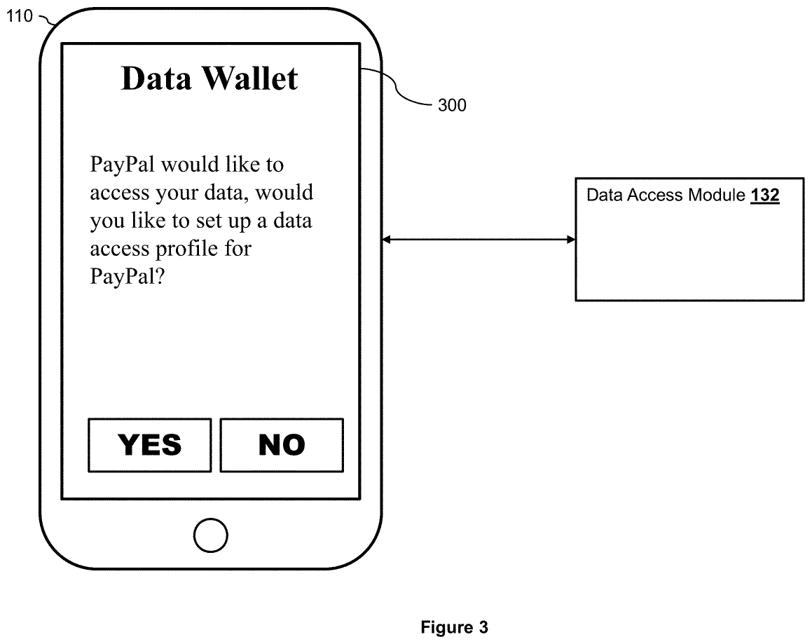

FIG. 3 illustrates a user interface 300 that can be provided by the wallet application 116 on the user device 110 in response to receiving a data access request from the data access module 132 of the service provider server 130. Upon determining that the data access settings for the service provider server 130 have not been specified, the wallet application 116 may provide the user interface 300 on the user device 110 to prompt the user 140 to set up a data access profile for the service provider server 130.

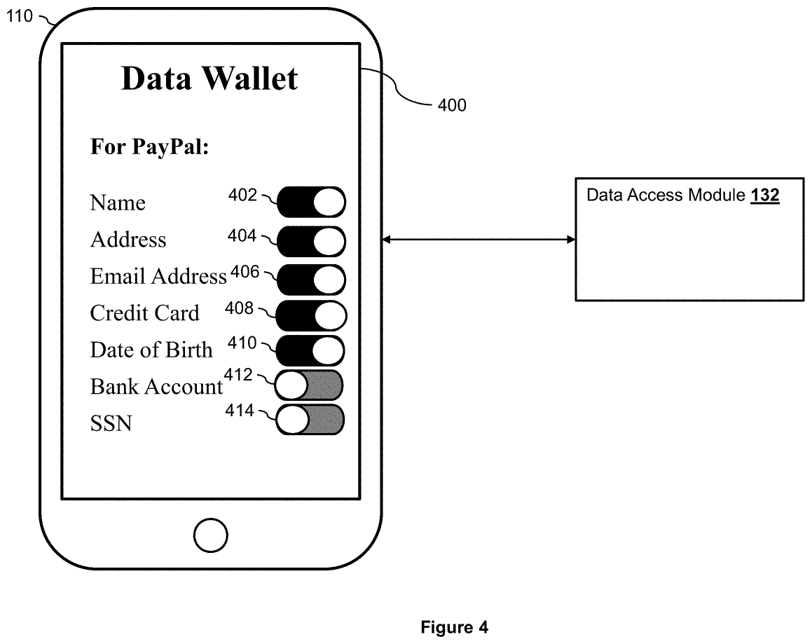

If the user 140 selects “no,” the wallet application 116 may deny the data access module 132 access to the requested user data. On the other hand, if the user 140 selects “yes,” the wallet application 116 may provide another user interface that enables the user to specify a data access profile for the service provider server 130. FIG. 4 illustrates a user interface 400 provided by the wallet application 116 that enables the user 140 to set up a data access profile for the service provider server 130. As shown in FIG. 4, the user interface 400 presents different data types corresponding to the user data provided by the user 140, such as a name data type, an address data type, an email address data type, a credit card information data type, a date of birth data type, a bank account information data type, and a social security number data type. The user data corresponding to these data types might have been previously provided by the user 140 to the wallet application 116 and stored on the user device 110.

The wallet application 116 may also provide, on the user interface 400 control elements 402-414. The user 140 may manipulate the control elements 402-414 to specify different data access settings corresponding to the different data types for the data access profile of the service provider server 130. In this example, the control elements 402-414 are implemented as toggles, through which the user 140 can specify between two data access settings (e.g., allowed, not allowed, etc.) for each of the data type. In this example, based on the inputs provided via the control elements 402-414, the user 140 may specify that the service provider server 130 may be allowed to access user data corresponding to the name data type, the address data type, the email address data type, the credit card data type, and the date of birth, and that the service provide server 130 may not be allowed to access user data corresponding to the bank account and the social security number data type.

While the control elements 402-414 are implemented as two-way toggles in this example, other control elements provided by the wallet application 116 may be implemented differently. For example, the wallet application 116 may provide control elements that enable the user 140 to specify data access settings in a finer detail, such as a three-way option (e.g., always allow, always prompt user, and never allow). In another example, the wallet application 116 may also provide additional setting criteria such as a time of day, a geographical location, a type of request, or other criteria. This way, the user 140 can provide specific instructions as to when or in what circumstances certain user data can be shared with a particular data requester.

In some embodiments, the data access module 132 may automatically configure data access profiles for the service provider server 130 and other service providers (e.g., the merchant server 120, etc.) in a wallet application (e.g., the wallet application 116). For example, the data access module 132 may obtain data access profiles specified for different service providers by different users from different wallet applications (e.g., the wallet application 116, the wallet application 186, the wallet application 196, etc.). The data access module 132 may also obtain user attributes of the users associated with the wallet applications. The user attributes may not correspond to sensitive user data, and may include age information, gender information, geographical location information, etc. Based on the data access profiles and the user attributes, the data access module 132 may generate different data access profile models for different service providers based on the user attributes. For example, the data access module 132 may generate a data access profile model for the service provider server 130 based on the data access settings specified by different users for the service provider server 130.

In some embodiments, the data access module 132 may generate different data access profile models for the same service provider (e.g., the service provider server 130) based on different user attributes (e.g., age, gender, demographic, etc.). For example, the data access module 132 may generate a first data access profile model for the service provider server 130 based on users who are under a certain age threshold (e.g., 35, 50, etc.) and a second data access profile model for the service provider server 130 based on users who are above the certain age threshold (e.g., 35, 50, etc.). In another example, the data access module 132 may generate a first data access profile model for the service provider server 130 based on male users and a second data access profile model for the service provider server 130 based on female users. In yet another example, the data access module 132 may generate a first data access profile model for the service provider server 130 based on users who are located in a first geographical location and a second data access profile model for the service provider server 130 based on users located in a second geographical location.

The data access module 132 may then determine one or more data access profiles corresponding to one or more service providers (e.g., the service provider server 130, the merchant server 120, etc.) for a user (e.g., the user 140) based on the data access profile models and user attributes of the user (e.g., an age of the user 140, a gender of the user 140, a location of the user 140, etc.). The data access module 132 may automatically configure a wallet application of the user (e.g., the wallet application 116) for the user without requiring inputs from the user 140. After configuring the wallet application 116, the data access module 132 may cause the wallet application 116 to prompt the user 140, via a user interface provided on the user device 110, to confirm and/or edit the data access settings.

In some embodiments, the data access module 132 may store copies of the data access profile models in edge computing devices within a network (e.g., a cellular network, a local area network, etc.) such that the data access profile models can be pushed to the user devices (e.g., the user device 110, the user device 180, the user device 190, etc.) quickly. In some embodiments, the wallet application 116 may access the data access profile models stored on the edge devices at different time instances (e.g., periodically), such that the wallet application 116 may dynamically adjust the data access profiles for the different service providers, for example, based on a current location of the user device.

Referring back to FIG. 2, the wallet application 116 may determine whether to provide the data access module 132 access to the user data 220 based on the data access settings specified in the data access profile for the service provider server 130. If the data access settings corresponding to the requested data types indicate that the service provider server 130 may not be allowed access to any of the user data 220, the wallet application 116 may deny the data access request. On the other hand, if the data access settings corresponding to the requested data types indicate that the service provider server 130 may be allowed to access the user data 220, the wallet application 116 may provide the user data 220 to the data access module 132 through the wallet interface 204. In some embodiments, based on the specific data access settings, the wallet application 116 may prompt the user 140 to confirm the data access before providing the user data 220 to the data access module 132.

In some embodiments, in addition to the data access settings, the wallet application 116 may also determine whether to grant the service provider access to the user data based on the type of transaction that the user data is being used for. As discussed herein, certain data types may be required for processing certain types of transactions. However, a service provider may sometimes request more user data than is required for processing a transaction. As such, the wallet application 116 may determine a set of data types that is required to process a transaction based on the data access request (e.g., the request may indicate a reason for accessing the user data). In some embodiments, the wallet application 116 may determine the set of data types based on previous data access requests received by other service provider. In some embodiments, the data access module 132 may determine types of user data required for different transaction types based on previous data access requests submitted to various wallet applications over a period of time. The data access module 132 may store such information in the edge devices (e.g., edge nodes) as discussed herein. The wallet application 116 may then access the information from an edge node and may use the information to determine the required user data type for process the transaction. If it is determined that more user data is requested for processing the transaction than necessary, the wallet application 116 may deny the data access request. Alternatively, the wallet application 116 may negotiate with the service provider (via a communication channel) regarding the types of user data that is needed to process the transaction. The service provider may submit a modified data access request (for accessing a modified set of user data). The wallet application 116 may then grant the service provider access to the modified set of user data.

Upon receiving the user data 220, the data access manager 202 may store the user data 220 in a data storage 260 that is separate from the account database 136. In some embodiments, the data storage 260 is a non-persistent data storage (e.g., random-access memory). Furthermore, the data storage 260 is also accessible by the service application 138. Thus, the data access manager 202 may notify the service application 138 that the user data 220 is now available in the data storage 260. The service application 138 may then process the transaction (e.g., the purchase transaction) based on the user data 220. After the transaction has been processed, the service application 138 may present on the user interface application 112 a confirmation that the transaction has been processed. Since only the sanitized version of the user data is provided to the machine learning model(s), the risk of having sensitive user data being stored on the service provider server 130 is further reduced.

In some embodiments, the service application 138 may use one or more machine learning models when processing the transaction. For example, the service application 138 may use a risk model to predict a risk associated with the transaction, based at least in part on, the user data retrieved from the wallet application 116. It may not be desirable to provide certain portions of the user data 220 (that include sensitive user data) to the machine learning model as input values because information associated with the input values may be inadvertently retained within the machine learning model via the training and feedback mechanism. Thus, in some embodiments, the sanitization module 208 may create a mapping table 222 between sensitive user data (e.g., a name, a social security number, etc.) and their replacement values. The replacement values may be determined arbitrarily (e.g., randomly selected). After performing the prediction process using the machine learning model, the sanitization module 208 reverts the data using the mapping table 222, before proceeding with processing the transaction.

In some embodiments, after processing the transaction, the data access manager 202 may delete the user data 220 from the data storage 260. The service application 138 may produce transaction data associated with the processing of the transaction through the user account (e.g., the purchase transaction). The transaction data may include information associated with the transaction, such as a time of the day when the transaction was processed, merchant information such as a name and a merchant category, an amount, information representing the goods or services being purchased, a payment method, etc. In some embodiments, the data access manager 202 may use the sanitization module 208 to sanitize the transaction data by removing any sensitive data within the transaction data. For example, the sanitization module 208 may remove a credit card number while retaining a card type (e.g., a VISA® card, a MasterCard®, etc.). After sanitizing the transaction data, the data access manager 202 may store the sanitized data in the account database 136 for the user account. The transaction data may be used by the service application 138 or other applications (e.g., a risk assessment module) for determining a risk of a transaction request from a user.

In some embodiments, a user (e.g., the user 140) may, via the user interface application 112 of the user device 110 (or a user interface application of another device such as a work computer, a public computer, etc.), request to view information about the user account, such as a transaction history of the user account. The data access manager 202 may use the UI generation module 206 to generate a user interface template for the user account based on data associated with the user account stored in the account database 136. As discussed herein, the account database 136 may not store any sensitive data for the user, but may store non-sensitive data, such as partial transaction data for the user account. Thus, the UI generation module 206 may generate the user interface template based on the partial transaction data. The UI generation module 206 may create one or more placeholders on the user interface template for presenting user data that is not available in the account database 136 (e.g., a name, a payment card number, etc.). Each of the one or more placeholders may specify a data type that can been subsequently filled in with the corresponding user data.

The UI generation module 206 may send the user interface template to the user device 110 (or another user device used by the user 140). The user interface template may include programming code, that when executed by the user interface application 112 of the user device 110 (or a user interface application of another user device used by the user 140), causes the user interface application to access user data from the wallet application 116 of the user device 110. The user interface application, based on executing the programming code of the user interface template, may retrieve the missing user data from the wallet application 116 based on the data type specified by the one or more placeholders. The user interface application may then generate a user interface (e.g., a webpage) by integrating the user data retrieved from the wallet application 116 into the user interface template and present the user interface on the user device 110 (or another user device used by the user 140).

By using the secured electronic transaction processing framework and associated techniques described herein, the service provider server 130 may process transactions and present user account information for users without having to persistently store sensitive user data within the service provider server 130. Furthermore, the secured electronic transaction processing framework is scalable. Specifically, each of the service providers (e.g., the merchant server 120, other service provider servers, third-party service provider servers, etc.) may include a data access module similar to the data access module 132 for accessing and managing user data such that all of the service providers may process transactions for the users without persistently storing sensitive user data of the users.

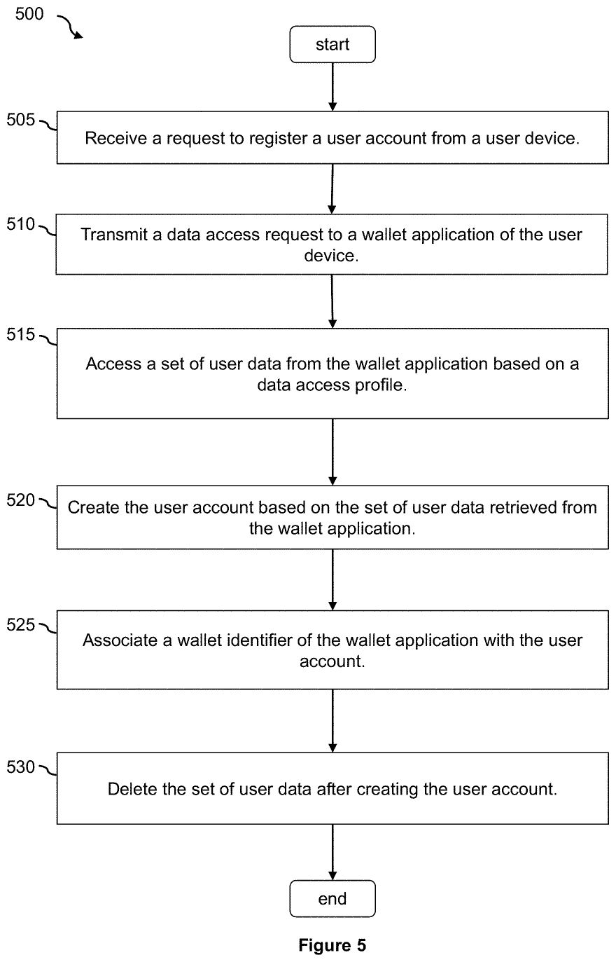

FIG. 5 illustrates a process 500 for using the secured electronic transaction processing framework to create a new user account for a user according to various embodiments of the disclosure. In some embodiments, at least a portion of the process 500 may be performed by the data access module 132. The process 500 may begin by receiving (at step 505) a request to register a user account from a user device. For example, the interface server 134 may receive an onboarding request from a user device (e.g., the user device 110). Upon receiving the onboarding request, the data access manager 202 may use the data types determination module 210 to determine the data types that are required for processing the onboarding request. In order to create a new user account for a new user, the service application 138 may typically require user data of the user for assessing a trustworthiness of the user. For example, the service application 138 of some embodiments may use a third-party service provider (e.g., a credit bureau) to evaluate a credit worthiness of a user based on information such as a social security number, an address, and other personal information. Conventionally, the service application 138 may prompt, via the interface server 134, the user for such user data. The service application may then share the user data with the third-party service provider such that the third-party service provider may evaluate a credit worthiness of the user based on the user data shared by the service application 138.

However, under the secured electronic transaction processing framework, the service provider server 130 may not share user data with any third-party servers and may not obtain data that is not required for the service provider server 130 to process a request. Thus, in this example, the data types determination module 210 may determine that only a name data type is required for processing the onboarding request.

The process 500 then transmits (at step 510) a data access request to a wallet application of the user device and accesses (at step 515) a set of user data from the wallet application based on a data access profile. For example, the data access manager 202 may use the wallet interface 204 to establish a connection with the wallet application of the user device (e.g., the wallet application 116 of the user device 110). The data access manager 202 may request access of user data of the user corresponding to the name data type. As discussed herein, the wallet application 116 may provide the data access module 132 access to the user data based on data access settings associated with the service provider server 130 (e.g., a data access profile associated with the service provider server 130).

Upon receiving the name of the user from the wallet application 116, the data access manager 202 may share the user data with the service application 138 for processing the onboarding request. As discussed herein, in order to process the onboarding request, the service application 138 may need a credit worthiness assessment provided by a third-party service provider (e.g., a credit bureau). Instead of providing the user data to the third-party service provider to evaluate the credit worthiness of the user, the service application 138 may request the third-party service provider to directly access the user data from the user 140 (e.g., via the wallet application 116). Thus, the service application 138 may transmit a wallet identifier associated with the wallet application 116 to the third-party service provider. The third-party service provider may access the user data from the wallet application 116 directly. For example, the third-party service provider may also include a data access module similar to the data access module 132 for communicating with various wallet applications and accessing user data from the wallet applications. Accordingly, the third-party service provider may directly request access to the user data (e.g., a name, a social security number, an address, etc.) to the wallet application 116. The wallet application 116 may provide (or deny) access to the user data based on another data access profile associated with the third-party service provider. Based on the user data obtained from the wallet application 116, the third-party service provider may determine a credit worthiness of the user 140 and provide the result to the service application 138.

The process 500 then creates (at step 520) the user account based on the set of user data retrieved from the wallet application and associates (at step 525) a wallet identifier of the wallet application with the user account. For example, the service application 138 may process the onboarding request based on the user data obtained from the wallet application 116 and the result provided by the third-party service provider. By creating the user account, the service application 138 may create a new record in the account database 136 for the user account. As discussed herein, the service provider may not store any sensitive user data of the user 140. Thus, the service application 138 may not store some or all of the user data obtained from the wallet application 116 in the account database 136. Instead, after creating a user account for the user 140, the service application 138 may store a wallet identifier associated with the wallet application 116 in the account database 136 in association with the user account, such that the data access module 132 may access the user data from the wallet application 116 for processing any subsequent requests for the user account.

The process 500 then deletes (at step 530) some or all of the set of user data after creating the user account. For example, the data access manager 202 may delete the user data from the data storage 260 after the onboarding request is processed.

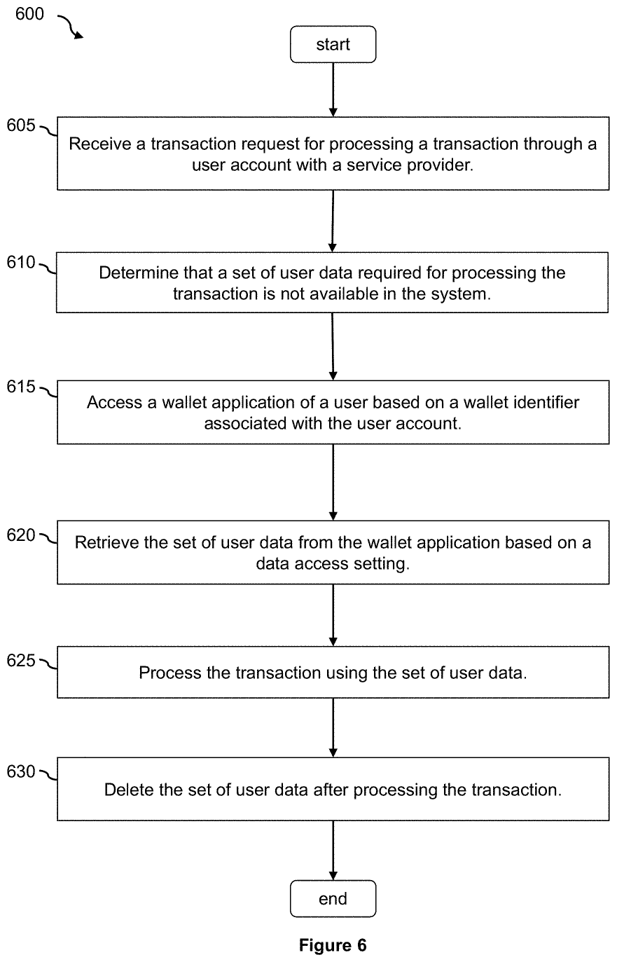

FIG. 6 illustrates a process 600 for using the secured electronic transaction processing framework to process a transaction request for a user according to various embodiments of the disclosure. In some embodiments, at least a portion of the process 600 may be performed by the data access module 132. The process 600 may begin by receiving (at step 605) a transaction request for processing a transaction through a user account with a service provider and determining (at step 610) that a set of user data is required for processing the transaction is not available in the system. For example, the interface server 134 may receive a transaction request from a user device (e.g., the user device 110). Upon receiving the transaction request, the data access manager 202 may use the data types determination module 210 to determine the data types that are required for processing the transaction request. In one example, the transaction request may be a request to process a purchase transaction. In order to process the transaction request, the service application 138 may require financial information associated with a payment source (e.g., a bank account, a payment card, etc.). Thus, the data types determination module 210 may determine that a name data type, a payment card information data type, and a shipping address data type are required for processing the transaction request.

The process 600 then accesses (at step 615) a wallet application of a user based on a wallet identifier associated with the user account and retrieves (at step 620) the set of user data from the wallet application based on a data access setting. For example, the data access manager 202 may obtain a wallet identifier associated with the user account from the account database 136. The data access manager 202 may use the wallet interface 204 to establish a connection with the wallet application of the user device (e.g., the wallet application 116 of the user device 110) based on the wallet identifier. The data access manager 202 may request access of user data of the user corresponding to the name data type, the payment card information data type, and an address data type. As discussed herein, the wallet application 116 may provide the data access module 132 access to the user data based on data access settings associated with the service provider server 130 (e.g., a data access profile associated with the service provider server 130).

The process 600 processes (at step 625) the transaction using the set of user data and deletes (at step 630) some or all of the set of user data after processing the transaction. Upon receiving the user data (e.g., a name, payment card information, a shipping address, etc.) of the user from the wallet application 116, the data access manager 202 may share the user data with the service application 138 for processing the transaction request. For example, the data access manager 202 may store the user data in the data storage 260 and enables the service application 138 to access the user data in the data storage 260. The service application 138 may process the transaction request (e.g., by processing a credit card payment to a payee such as a merchant associated with the merchant server 120) based on the user data. After processing the transaction request, the data access manager 202 may delete some or all of the user data from the data storage 260.

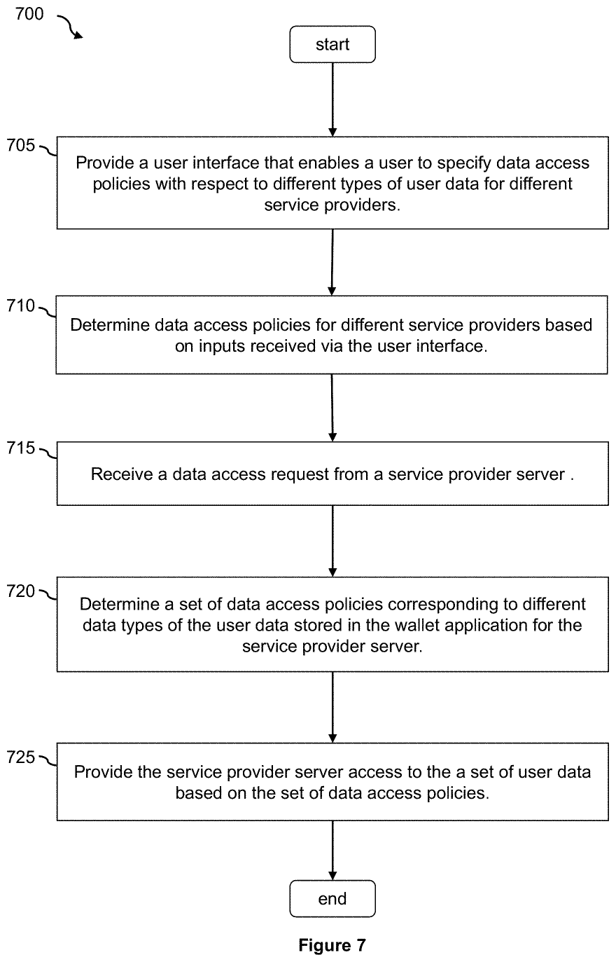

FIG. 7 illustrates a process 700 for providing user data to different service providers according to various embodiments of the disclosure. In some embodiments, at least a portion of the process 700 may be performed by any one of the wallet applications (e.g., the wallet application 116, the wallet application 186, the wallet application 196, etc.). The process 700 may begin by providing (at step 705) a user interface that enables a user to specify data access policies with respect to different types of user data for different service providers and determining (at step 710) user access policies for different service providers based on inputs received via the user interface. For example, the wallet application may provide a user interface similar to the user interface 400 in FIG. 4 for obtaining data access configuration inputs from a user. Based on the inputs received via the control elements presented on the user interface 400, the wallet application may configure different data access profiles for different service providers. Each data access profile may specify data access settings corresponding to different data types for a particular service provider.

The process 700 receives (at step 715) a data access request from a service provider server. For example, the wallet application may receive a data access request from the data access module 132 of the service provider server 130. The data access request may include a set of data types that the data access module 132 desires to access for processing a transaction for a user account.

The process 700 then determines (at step 720) a set of data access policies corresponding to different data types of the user data stored in the wallet application for the service provider server and provides (at step 725) the service provider server access to the set of user data based on the set of data access policies. For example, the wallet application may obtain a data access profile associated with the service provider server 130. The data access profile may specify the data access settings (e.g., always allow, allow once, always deny, etc.) for different data types. Based on the data access settings specified in the data access profile associated with the service provider server 130, the wallet application may provide the service provider server access to the set of data. For example, if the data access settings indicated that the service provider server 130 is allowed to access the requested user data, the wallet application may transmit the user data to the service provider server 130. On the other hand, if the data access settings indicated that the service provider server 130 is not allowed to access at least some of the requested user data, the wallet application may deny the request by transmitting an error message to the service provider server 130.

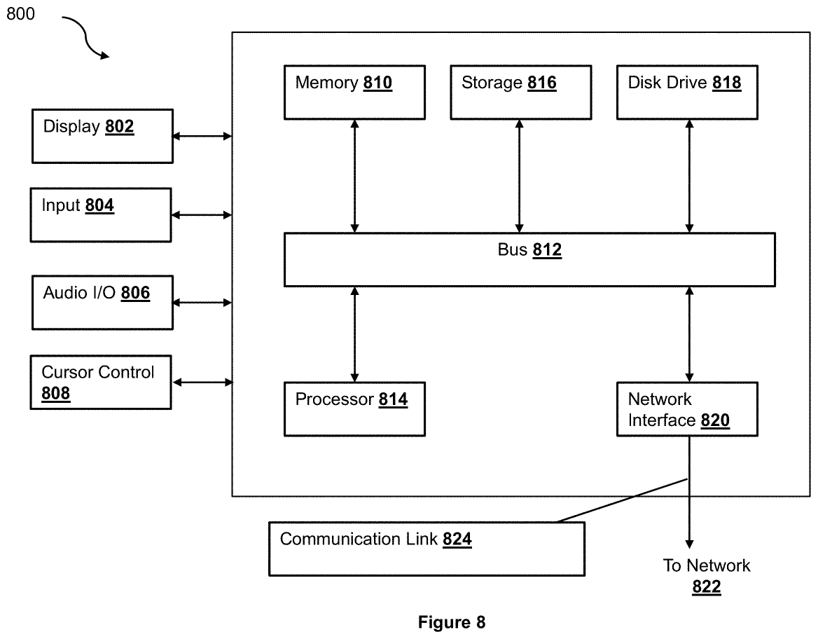

FIG. 8 is a block diagram of a computer system 800 suitable for implementing one or more embodiments of the present disclosure, including the service provider server 130, the merchant server 120, and the user devices 110, 180, and 190. In various implementations, each of the devices 110, 180, and 190 may include a mobile cellular phone, personal computer (PC), laptop, wearable computing device, etc. adapted for wireless communication, and each of the service provider server 130 and the merchant server 120 may include a network computing device, such as a server. Thus, it should be appreciated that the devices/servers 110, 120, 130, 180, and 190 may be implemented as the computer system 800 in a manner as follows.

The computer system 800 includes a bus 812 or other communication mechanism for communicating information data, signals, and information between various components of the computer system 800. The components include an input/output (I/O) component 804 that processes a user (i.e., sender, recipient, service provider) action, such as selecting keys from a keypad/keyboard, selecting one or more buttons or links, etc., and sends a corresponding signal to the bus 812. The I/O component 804 may also include an output component, such as a display 802 and a cursor control 808 (such as a keyboard, keypad, mouse, etc.). The display 802 may be configured to present a login page for logging into a user account or a checkout page for purchasing an item from a merchant. An optional audio input/output component 806 may also be included to allow a user to use voice for inputting information by converting audio signals. The audio I/O component 806 may allow the user to hear audio. A transceiver or network interface 820 transmits and receives signals between the computer system 800 and other devices, such as another user device, a merchant server, or a service provider server via a network 822, such as network 160 of FIG. 1. In one embodiment, the transmission is wireless, although other transmission mediums and methods may also be suitable. A processor 814, which can be a micro-controller, digital signal processor (DSP), or other processing component, processes these various signals, such as for display on the computer system 800 or transmission to other devices via a communication link 824. The processor 814 may also control transmission of information, such as cookies or IP addresses, to other devices.

The components of the computer system 800 also include a system memory component 810 (e.g., RAM), a static storage component 816 (e.g., ROM), and/or a disk drive 818 (e.g., a solid-state drive, a hard drive). The computer system 800 performs specific operations by the processor 814 and other components by executing one or more sequences of instructions contained in the system memory component 810. For example, the processor 814 can perform the data access control and management functionalities described herein according to the processes 500, 600, and 700.

Logic may be encoded in a computer readable medium, which may refer to any medium that participates in providing instructions to the processor 814 for execution. Such a medium may take many forms, including but not limited to, non-volatile media, volatile media, and transmission media. In various implementations, non-volatile media includes optical or magnetic disks, volatile media includes dynamic memory, such as the system memory component 810, and transmission media includes coaxial cables, copper wire, and fiber optics, including wires that comprise the bus 812. In one embodiment, the logic is encoded in non-transitory computer readable medium. In one example, transmission media may take the form of acoustic or light waves, such as those generated during radio wave, optical, and infrared data communications.

Some common forms of computer readable media include, for example, floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, or any other medium from which a computer is adapted to read.

In various embodiments of the present disclosure, execution of instruction sequences to practice the present disclosure may be performed by the computer system 800. In various other embodiments of the present disclosure, a plurality of computer systems 800 coupled by the communication link 824 to the network (e.g., such as a LAN, WLAN, PTSN, and/or various other wired or wireless networks, including telecommunications, mobile, and cellular phone networks) may perform instruction sequences to practice the present disclosure in coordination with one another.

Where applicable, various embodiments provided by the present disclosure may be implemented using hardware, software, or combinations of hardware and software. Also, where applicable, the various hardware components and/or software components set forth herein may be combined into composite components comprising software, hardware, and/or both without departing from the spirit of the present disclosure. Where applicable, the various hardware components and/or software components set forth herein may be separated into sub-components comprising software, hardware, or both without departing from the scope of the present disclosure. In addition, where applicable, it is contemplated that software components may be implemented as hardware components and vice-versa.

Software in accordance with the present disclosure, such as program code and/or data, may be stored on one or more computer readable mediums. It is also contemplated that software identified herein may be implemented using one or more general purpose or specific purpose computers and/or computer systems, networked and/or otherwise. Where applicable, the ordering of various steps described herein may be changed, combined into composite steps, and/or separated into sub-steps to provide features described herein.

The various features and steps described herein may be implemented as systems comprising one or more memories storing various information described herein and one or more processors coupled to the one or more memories and a network, wherein the one or more processors are operable to perform steps as described herein, as non-transitory machine-readable medium comprising a plurality of machine-readable instructions which, when executed by one or more processors, are adapted to cause the one or more processors to perform a method comprising steps described herein, and methods performed by one or more devices, such as a hardware processor, user device, server, and other devices described herein.

1. A system, comprising:
one or more hardware processors; and
a non-transitory memory storing instructions that, when executed by the one or more hardware processors, cause the one or more hardware processors to perform operations comprising:
receiving, from a user device, a request to perform a transaction through a user account with a service provider;
determining that a set of user data associated with the user account is required for processing the transaction;
accessing a local data storage that stores information associated with the user account;
determining, from the set of user data, that a subset of user data corresponding to a set of data types is missing from the local data storage;
in response to determining that the subset of user data is missing from the local data storage, retrieving, from the local data storage, a wallet identifier corresponding to the user account;
establishing, via a wallet interface, a connection with a wallet application of the user device based on the wallet identifier, wherein the user device is not part of the system;
transmitting, via the wallet interface, a data access request to the wallet application, wherein the data access request specifies the set of data types, and wherein the wallet application is configured to provide data access to the service provider based on a data access setting stored in the wallet application in association with the service provider;
obtaining, from the wallet application via the wallet interface, the subset of user data associated with the user account and required for the processing of the transaction;
processing the transaction through the user account based at least in part on the subset of user data; and
subsequent to the processing of the transaction, removing the subset of user data from the system.

2. The system of claim 1, wherein the operations further comprise:
generating a user interface for presenting account information associated with the user account and stored in the local data storage, wherein the user interface lacks user identifiable data associated with the user account;
causing a user interface application of the user device to access the user identifiable data stored in the wallet application of the user device and to integrate the user identifiable data into the user interface; and
presenting, on the user device via the user interface application, the user interface comprising the integrated user identifiable data.

3. The system of claim 2, wherein the user interface application is different from the wallet application.

4. The system of claim 1, wherein the operations further comprise:
presenting, on the user device via the wallet application, a data access alert indicating an identity of the service provider and the set of data types corresponding to the subset of user data accessed by the service provider.

5. The system of claim 1, wherein the operations further comprise:
determining that the processing of the transaction requires a service from a third-party service provider; and
in response to the determining that the processing of the transaction requires the service from the third-party service provider, transmitting the wallet identifier to a third-party server associated with the third-party service provider.

6. The system of claim 5, wherein the wallet identifier enables the third-party server to access a second set of user data from the wallet application of the user device.

7. The system of claim 5, wherein the operations further comprise:
storing the subset of user data obtained from the wallet application; and
restricting the third-party provider from accessing the subset of user data.

8-13. (canceled)

14. A non-transitory machine-readable medium having stored thereon machine-readable instructions executable to cause a machine to perform operations comprising:
receiving, from a first user device, a request to perform a transaction through a user account with a service provider;
determining that a set of user data associated with the user account and required for processing the transaction is missing from a data storage that stores information associated with the user account;
retrieving, from the data storage, a wallet identifier corresponding to the user account;
transmitting a data access request to a wallet application of a second user device based on the wallet identifier, wherein the data access request specifies a set of data types corresponding to the set of user data, and wherein the wallet application is configured to provide data access based on a data access setting stored in the wallet application;
obtaining, from the wallet application, the set of user data associated with the user account and required for the processing the transaction;
processing the transaction through the user account based at least in part on the set of user data; and
subsequent to the processing of the transaction, removing at least a first portion of the set of user data from the machine.

15. The non-transitory machine-readable medium of claim 14, wherein the operations further comprising:
in response to the processing of the transaction, presenting, on the first user device, a confirmation of the transaction, wherein the confirmation comprises at least a second portion of the set of user data retrieved from the second user device.

16. The non-transitory machine-readable medium of claim 14, wherein the operations further comprise:
receiving, from the second user device, a registration request;
in response to receiving the registration request, transmitting, to the wallet application of the second user device, a second data access request for accessing a second set of user data;
creating the user account based on the second set of user data, wherein the creating of the user account comprises linking the user account with the wallet application of the second user device based on the wallet identifier; and
subsequent to the creating of the user account, removing at least a portion of the second set of user data from the machine.

17. The non-transitory machine-readable medium of claim 14, wherein the data access setting comprises an access policy for each of a plurality of data types corresponding to user data stored in the wallet application, and wherein the access policy is one of an always allow policy, an allow once policy, or a never allow policy.

18. The non-transitory machine-readable medium of claim 14, wherein the operations further comprise:
obtaining transaction data associated with the transaction;
sanitizing the transaction data by removing user identifiable data from the transaction data; and
storing the sanitized transaction data in a data storage.

19. The non-transitory machine-readable medium of claim 14, wherein the operations further comprise:
presenting, on the second user device via the wallet application, a data access alert indicating an identity of the service provider, the set of data types corresponding to the set of user data, and a device identifier of the first user device.

20. The non-transitory machine-readable medium of claim 14, wherein the operations further comprise:
determining that the processing of the transaction requires a service from a third-party provider; and
in response to determining that the processing the transaction requires the service from the third-party provider, transmitting the wallet identifier to a third-party server associated with the third-party provider.

21. A method comprising:
receiving, by one or more hardware processors associated with a service provider and from a user device, a request to perform a transaction through a user account with the service provider;
determining, by the one or more hardware processors, that a set of user data associated with the user account is required for processing the transaction;
accessing, by the one or more hardware processors, a data storage associated with the service provider, wherein the data storage stores information associated with the user account;
determining, from the set of user data, that a subset of user data corresponding to a set of data types is missing from the data storage;
retrieving, from the data storage, a wallet identifier corresponding to the user account;
establishing, via a wallet interface, a connection with a wallet application of the user device based on the wallet identifier;
transmitting, via the wallet interface, a data access request to the wallet application, wherein the data access request specifies the set of data types, and wherein the wallet application is configured to provide data access to the service provider based on a data access setting stored in the wallet application;
obtaining, from the wallet application via the wallet interface, the subset of user data associated with the user account and required for the processing of the transaction;
processing the transaction through the user account based at least in part on the subset of user data; and
subsequent to the processing of the transaction, deleting the subset of user data.

22. The method of claim 21, further comprising:
generating a user interface for presenting account information associated with the user account and stored in the data storage, wherein the user interface lacks user identifiable data associated with the user account;
accessing, via a user interface application of the user device, the user identifiable data stored in the wallet application of the user device;
integrating the user identifiable data into the user interface; and
presenting, on the user device via the user interface application, the user interface comprising the integrated user identifiable data.

23. The method of claim 21, further comprising:
presenting, on the user device via the wallet application, a data access alert indicating an identity of the service provider and the set of data types corresponding to the subset of user data accessed by the service provider.

24. The method of claim 21, wherein the operations further comprise:
determining that the processing of the transaction requires a service from a third-party service provider; and
in response to the determining that the processing of the transaction requires the service from the third-party service provider, transmitting the wallet identifier to a third-party server associated with the third-party service provider.

25. The method of claim 24, wherein the wallet identifier enables the third-party server to access a second set of user data from the wallet application of the user device.

26. The method of claim 24, further comprising:
restricting the third-party provider from accessing the subset of user data obtained from the wallet application.
